(19) United States
(12) Patent Application Publication
(10) Pub. No.: US 2008/0129861 A1
(43) Pub. Date: Jun. 5, 2008

(54) METHOD OF TRANSMITTING COLOR GAMUT INFORMATION AND IMAGE DEVICE USING THE SAME

(75) Inventors: Dong-bum CHOI, Suwon-si (KR); Kyong-wook KIM, Suwon-si (KR); Il-do KIM, Seoul (KR); Soo-young KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/938,425

(22) Filed: Nov. 12, 2007

(30) Foreign Application Priority Data
Nov. 30, 2006 (KR) 10-2006-0119828

(51) Int. Cl. H04N 11/02; G06K 9/00; H04N 9/64

(52) U.S. Cl. 348/432.1; 348/708; 382/162; 348/E09.037; 348/E05.096

(57) ABSTRACT

A method of transmitting color gamut information and an image device using the same are provided. The image device includes a color gamut information generating unit which generates color gamut information; an ancillary data generating unit which generates ancillary data including the color gamut information; and a composition unit which combines the ancillary data and image data. Since the image device reproduces an image based on the color gamut information, the quality deterioration of the image may be prevented.

### CROSS-REFERENCE TO RELATED APPLICATIONS

This application claims priority from Korean Patent Application No. 10-2006-0119828, filed on Nov. 30, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to transmitting color gamut information and an image device, and more particularly, to transmitting and receiving color gamut information of image data and an image device.

2. Description of the Related Art

Generally, a recording medium storing a file is built in an image device (for example, a digital camcorder, a TV or a set-top box). Accordingly, the image device is capable of reproducing the file stored in the built-in recoding medium.

An image device may also be connected to an exterior device, thereby enabling communication therebetween. Since the image device and the exterior device are connected to enable communication therebetween, the image device is capable of reproducing a file stored in a recording medium built in the exterior device.

When an image device reproduces an image, it is based on a specific color gamut. The range of the color gamut is increasing as improved image devices are being developed.

FIG. 1 is a view of a color range, based on a standard YCbCr signal. From the origin, the X axis represents values of a luminance signal Y, and the Y axis represents values of a chromaticity signal C. As illustrated in FIG. 1, the color spaces are wider in order of a color gamut 110 of the sRGB signal, a color gamut 120 of the sYCC signal, and a color gamut 130 of the xvYCC signal.

Thus, when an image expressed in the color gamut 130 of the xvYCC signal is reproduced in an image device supporting the color gamut 110 of the sRGB signal, the image quality deteriorates and errors may occur when processing signals of the image.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method for transmitting color gamut information, wherein data including the color gamut information of an image is separately generated and transmitted, with the image, to an image device; so that the image device receiving the image with the data reproduces the image based on the color gamut information, and an image device using the same.

According to an aspect of the present invention, there is provided an image device comprising: a color gamut information generating unit which generates color gamut information; an ancillary data generating unit which generates ancillary data; and a composition unit which combines the ancillary data and image data.

The color gamut information may be included in any one of a data identification (ID) section and a user data words section which are included in the ancillary data.

The ancillary data generating unit may generate ancillary data so that the data ID section includes information on whether the color gamut information is included in the ancillary data or not, and the user data words section includes the color gamut information.

The color gamut information may be the information of any one of a color gamut of the sYCC signal, a color gamut of the sRGB signal, and a color gamut of the xvYCC signal.

According to another aspect of the prevent invention, there is provided an image device comprising: a data receiving unit which receives data image data and ancillary data; and a color gamut information extracting unit which extracts color gamut information from the ancillary data.

The image device may further comprise: a signal processing unit which signal-processes the image data, by using the extracted color gamut information.

The color gamut information may be included in any one of a data ID section and a user data words section which are included in the ancillary data.

The color gamut information extracting unit may extract information on whether the color gamut information is included in the ancillary data from the data ID section and may extract the color gamut information from the user data words section.

In accordance with another aspect of the present invention, there is provided a method of transmitting color gamut information, comprising: generating color gamut information; generating ancillary data including the color gamut information; and composing the ancillary data and image data.

The color gamut information may be included in any one of a data ID section and a user data words section which are included in the ancillary data.

The generating of the ancillary data may comprise color gamut ID, that is, information on whether the color gamut information is included in the ancillary data, in the data ID section, and may comprise the color gamut information in the user data words section.

The color gamut information may be the information of any one of a color gamut of the sYCC signal, a color gamut of the sRGB signal, and a color gamut of the xvYCC signal.

According to another aspect of the prevent invention, there is provided a method of receiving color gamut information, comprising: receiving data including image data and ancillary data; and extracting color gamut information from the ancillary data.

The method of receiving color gamut information may further comprise: signal-processing the image data by using the extracted color gamut information.

The color gamut information may be included in any one of a data ID section and a user data words section which are included in the ancillary data.

The extracting of the color gamut information may extract color gamut ID, that is, information on whether the color gamut information is included in the ancillary data, from the data ID section, and may extract the color gamut information from the user data words section.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view of a color gamut, based on a standard YCbCr signal;

FIG. 2 is a block diagram of an image device which generates ancillary data including color gamut information, according to an exemplary embodiment of the present invention;

FIGS. 3A and 3B are views of types of an ancillary data packet;

FIG. 4 is a flow chart for explaining a method of transmitting color gamut information, by generating ancillary data including the color gamut information and image data, according to another exemplary embodiment of the present invention;

FIG. 5 is a block diagram of an image device which receives data, according to another exemplary embodiment of the present invention; and

FIG. 6 is a flow chart for explaining a method of reproducing image data, by extracting color gamut information included in ancillary data and using the extracted color gamut information, according to another exemplary embodiment of the present invention.

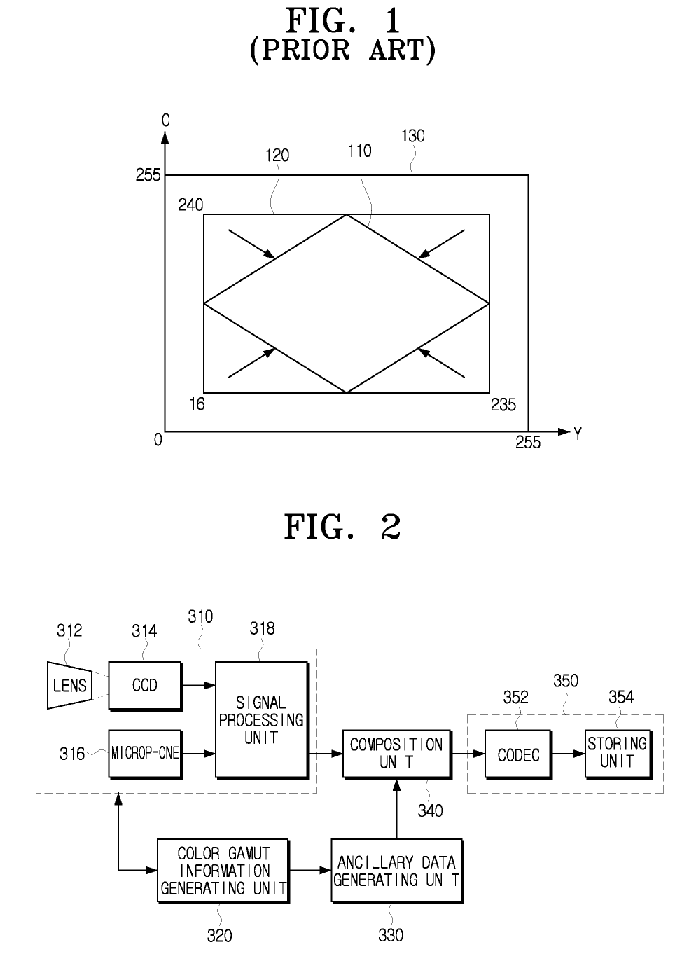

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

FIG. 2 is a block diagram of an image device which generates ancillary data including color gamut information, according to an exemplary embodiment of the present invention. As one of image devices, a digital camcorder may function as a transmitter which transmits color gamut information. The digital camcorder comprises an image data providing unit 310, a color gamut information generating unit 320, an ancillary data generating unit 330, a composition unit 340, and a data transmitting unit 350.

The image data providing unit 310 may comprise a lens 312, a charge-coupled device (CCD) 314, a microphone 316, and a signal processing unit 318.

The CCD 314 is an image sensor which picks up an optical image of a subject for photography being incident through the lens 312 and generates corresponding video signals. A complementary metal oxide semiconductor (CMOS) image sensor may be used, instead of the CCD 314.

The signal processing unit 318 removes noise, controls signal level, converts analogue signals to digital signals, and performs digital signal processing (DSP) with respect to the video signals (hereinafter, referred to as ‘image data’) which are output from the CCD 314. Further, the signal processing unit 318 amplifies audio signals which are output from the microphone 316 and converts the audio signals to digital signals.

The color gamut information generating unit 320 generates color gamut information of the image, by using the information transferred from the image data providing unit 310, and transfers the generated color gamut information to the ancillary data generating unit 330. Specifically, the color gamut information generating unit 320 determines whether the digital camcorder generating the image data supports a color gamut of the sYCC signal, a color gamut of the sRGB signal, and a color gamut of the xvYCC signal, and generates the color gamut information regarding the image being picked up, based on the aforementioned determination.

The ancillary data generating unit 330 generates ancillary data including the transferred color gamut information and transfers the ancillary data to the composition unit 340. The ancillary data generating unit 330 generates the ancillary data by storing the color gamut information in a portion for user application, among an ancillary data section. A detailed method thereof will be later described.

The composition unit 340 combines the ancillary data and the image data. This data may be stored in a storage, e.g. a buffer memory, of the composition unit 340. The composition unit transfers the data, which is composed of the image data and the ancillary data, to the data transmitting unit 350.

The data transmitting unit 350 transmits data and may be realized by a compressor-decompressor (CODEC) 352 and a storing unit 354. The CODEC 352 compresses the data transferred from the composition unit 340 and transfers the compressed data to the storing unit 354. The storing unit 354 stores the compressed image. A recording medium, such as a disk, which is attachable to or detachable from the storing unit 354 may be mounted on the storing unit.

To reproduce the image data, the recording medium, which stores the data including the image data and the ancillary data, may be mounted on another image device. Considering such a case, the CODEC 352 and the storing unit 354 are indicated as the data transmitting unit 350.

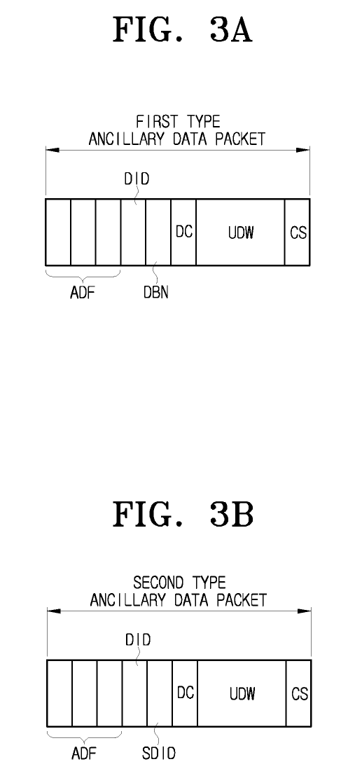

Types of the ancillary data generated by the ancillary data generating unit 330, and a method of storing the color gamut information in the ancillary data will be described. FIGS. 3A and 3B are views of the types of an ancillary data packet. The ancillary data packet may realized as a first type and a second type.

In FIG. 3A, the first type ancillary data packet comprises: an ancillary data flag (ADF), a data identification (DID), a data block number (DBN), a data count (DC), a user data words (UDW), and a checksum (CS).

The ancillary data flag informs a start point of data, and the data ID simply informs of information to which the ancillary data packet is related.

Specifically, the data ID includes a portion for user application, in addition to an already assigned ID, in the ancillary data. A color gamut ID, which simply informs information whether the color gamut information is present, is stored in the portion for user application.

The data block number indicates a length of a block of data. The data count indicates how many of user data words are described.

As the payload which is present in the ancillary data packet, the user data words are defined by the types of the ancillary data packets. In this application, the user data words mean a section where the color gamut information is stored. The checksum is a section for detecting an error of the packet.

In FIG. 3B, the second type ancillary data packet comprises: an ancillary data flag (ADF), a data identification (DID), a secondary data ID (SDID), a data count (DC), a user data words (UDW), and a checksum (CS).

In the second type ancillary data packet, the same sections as the first type ancillary data packet have the same functions as the first type ancillary data packet. Specifically, as a different section of the second type ancillary data packet from the first type ancillary data packet, the secondary data ID is effective when the data ID is at or less than a predetermined value. Then, the secondary data ID performs the same function as the data ID. The second type ancillary data packet may be used, together with the first type ancillary data packet, to transfer additional information or to transmit messages to a receiver.

When the ancillary data generating unit 330 which generates the ancillary data, described above, receives the color gamut information transferred from the color gamut information generating unit 320, the ancillary data generating unit 330 generates the ancillary data, by recording the color gamut ID in the portion for user application among the data ID, and recording the color gamut information in the user data words section.

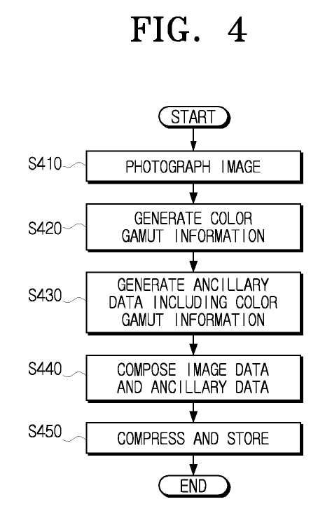

A method, by which the digital camcorder generates ancillary data including color gamut information and image data and transmits these data, will be described. FIG. 4 is a flow chart for explaining a method of transmitting color gamut information, by generating the ancillary data including the color gamut information and the image data, according to another exemplary embodiment of the present invention.

The digital camcorder picks up an image (S410). Specifically, a CCD 314 picks up an optical image of a subject for photography being incident through a lens 312 and transfers the image to a signal processing unit 318. A microphone 316 transfers sound to the signal processing unit 318. The signal processing unit 318 removes noise, converts analog signals to digital signals, and performs DSP regarding image data which are output from the CCD 314. The signal processing unit 318 amplifies audio signals being output from the microphone 316 and converts the amplified audio signals to digital signals.

A color gamut information generating unit 320 determines a color gamut of the image data of the image being photographed and generates color gamut information thereof (S420). Specifically, the color gamut information generating unit 320 determines which color gamut is supported by the digital camcorder. When the digital camcorder is determined as a device supporting a color gamut of the sYCC signal, the color gamut information generating unit 320 generates the color gamut information that the image data is the data realized by the color gamut of the sYCC signal.

An ancillary data generating unit 330 generates ancillary data, based on the color gamut information transferred from the color gamut information generating unit 320 (S430). That is, the ancillary data generating unit 330 generates the ancillary data, by making a color gamut ID as simple information regarding whether the color gamut information is present or not, recording the color gamut ID in a data ID section among the ancillary data, and recording the color gamut information in the user data words section. For example, when the image data being photographed is the data to be realized by the color gamut of the sYCC signal, the ancillary data generating unit 330 generates the ancillary data, to comprise the color gamut ID, indicating that the color gamut information is present, in the data ID section, and to comprise the color gamut information of the sYCC signal in the user data words section.

A composition unit 340 composes the signal processed image data and the ancillary data (S440).

A CODEC 352 compresses the data, which is transferred from the composition unit 340, into a predetermined format, and a storing unit 354 stores the compressed data in a recording medium within in the storing unit 354 (S450). Accordingly, the image data stored in the recording medium is reproducible in another image device.

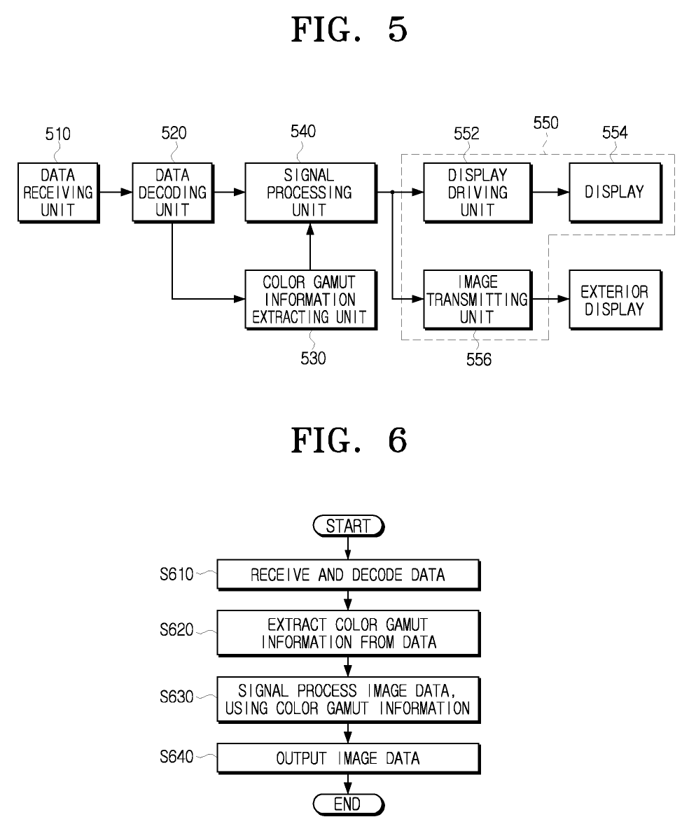

An image device which reproduces an image data by receiving data including an ancillary data, and a method of reproducing the image data will be described with reference to FIGS. 5 and 6. FIG. 5 is a block diagram of an image device which receives data, according to another exemplary embodiment of the present invention. In FIG. 5, the image device comprises a data receiving unit 510, a data decoding unit 520, a color gamut information extracting unit 530, a signal processing unit 540, and an image outputting unit 550.

The data receiving unit 510 transfers data received from exterior devices (for example, an exterior input terminal connected to a digital camcorder, an exterior set-top box, an exterior TV, and the like) to the data decoding unit 520. The data decoding unit 520 decodes the compressed data, transferred from the data receiving unit 510, to convert the data code into its original signals.

The color gamut information extracting unit 530 determines whether an ancillary data is present in the decoded data. When the ancillary data is present, the color gamut information extracting unit 530 extracts color gamut information from the ancillary data and transfers the extracted color gamut information to the signal processing unit 540. The signal processing unit 540 signal processes the image data of the decoded data. Then, the color gamut information provided from the color gamut information extracting unit 530 is used during the signal processing process.

The image outputting unit 550 outputs the image data to an interior display or exterior display. Specifically, when the image data is output to the interior display, a display driving unit 552 displays the transferred image signals to the interior display. When the image data is output to the exterior display, an image transmitting unit 556 transmits the transferred image signals to the exterior display (for example, an exterior TV).

FIG. 6 is a flow chart for explaining a method of reproducing image data, by extracting color gamut information included in ancillary data and using the extracted color gamut information, according to another exemplary embodiment of the present invention.

A data receiving unit 510 receives data from an exterior device, and a data decoding unit 520 decodes the received data (S610).

A color gamut information extracting unit 530 extracts color gamut information from the decoded data (S620). Specifically, the color gamut information extracting unit 530 determines whether ancillary data is present in the decoded data. When the color gamut information extracting unit 530 determines that the ancillary data is present, the color gamut information extracting unit 530 determines whether color gamut information is included in a specific section of the ancillary data, and extracts the color gamut information if it is included. The color gamut information extracting unit 530 may extract a color gamut ID from a data ID section of the ancillary data therein and may extract the color gamut information from a user data words section if the color gamut ID is present.

The signal processing unit 540 signal-processes the image data, based on the color gamut information transferred from the color gamut information extracting unit 530 (S630). When the extracted color gamut information is for a color gamut of the sYCC signal, the signal processing unit 540 signal-processes the image data, based on the color gamut of the sYCC signal.

Finally, the signal-processed image data is output (S640).

As described above, the color gamut information is recorded in the ancillary data, independently from the image data. Therefore, when the image is reproduced by an image device photographing the image or by another image device which specifically realizes an image within various color gamuts or realizes an image within the color gamut of the photographed image and another color gamut, either the original image quality may be realized or the image quality deterioration may be minimized.

In the exemplary embodiments of the present invention, the image device which performs a role of a transmitter is not limited to an image device which stores data to a recording medium. Since data is transferred to another image device by wire or wireless and is reproduced, the color gamut information transmitting unit may be an interface, instead of the CODEC 352 and the storing unit 354. When data is transmitted by wireless, the image device may further comprise a wireless modulation unit.

On the contrary, when the image device performs a role of a receiver, the image device may not include the data decoding unit 520. Or a single image device may have the functions of a transmitter and a receiver.

Further, the ancillary data including the color gamut information may comprise the color ID in the data ID section and the color gamut information in the user data words section but it may not be so limited. Therefore, the color gamut information may be recorded in the data ID section while any other information is not included in the user data words section. On the contrary, the color gamut information may be recorded in the user data words section while any other information is not included in the data ID section. Further, the color gamut information may be indicated in any other sections than the data ID and the user data words section, or the color gamut information may be indicated by partially changing the functions of the sections included in the ancillary data.

In the exemplary embodiments of the present invention, the color gamut of the sYCC signal, the color gamut of the sRGB signal and the color gamut of the xvYCC signal are mentioned as the color gamut information, but the color gamut information is not limited thereto.

As described above, in accordance with the exemplary embodiments of the present invention, the data including the color gamut information of an image is independently generated and transmitted, and an image device receiving the transferred image reproduces the image, based on the color gamut information, thereby preventing the quality deterioration of the image.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image device comprising:
a color gamut information generating unit which generates color gamut information;
an ancillary data generating unit which generates ancillary data including the color gamut information; and
a composition unit which combines the ancillary data and image data.

2. The image device as claimed in claim 1, wherein the color gamut information is included in at least one of a data identification (ID) and a user data words section which are included in the ancillary data.

3. The image device as claimed in claim 2, wherein the ancillary data generating unit generates the ancillary data, to include information within the data ID section indicating whether the color gamut information is included in the ancillary data, and to include the color gamut information in the user data words section.

4. The image device as claimed in claim 1, wherein the color gamut information comprises at least one of a color gamut of an sYCC signal, a color gamut of an sRGB signal, and a color gamut of an xvYCC signal.

5. The image device as claimed in claim 1, wherein the color gamut information generation unit generates the color gamut information based on the image data.

6. An image device comprising:
a data receiving unit which receives data including image data and ancillary data; and
a color gamut information extracting unit which extracts color gamut information from the ancillary data.

7. The image device as claimed in claim 6, further comprising:
a signal processing unit which signal-processes the image data based on the extracted color gamut information.

8. The image device as claimed in claim 7, wherein the color gamut information is included in at least one of a data identification (ID) and a user data words section which are included in the ancillary data.

9. The image device as claimed in claim 8, wherein the color gamut information extracting unit extracts information indicating whether the color gamut information is included in the ancillary data from the data ID section, and extracts the color gamut information from the user data words section.

10. A method of transmitting color gamut information, comprising:
generating color gamut information;
generating ancillary data including the color gamut information; and
composing the ancillary data and image data.

11. The method as claimed in claim 10, wherein the color gamut information is included in at least one of a data Identification (ID) and a user data words section which are included in the ancillary data.

12. The method as claimed in claim 11, wherein the generating of the ancillary data comprises storing a color gamut ID, which is information indicating whether the color gamut information is included in the ancillary data, in the data ID section, and storing the color gamut information in the user data words section.

13. The method as claimed in claim 10, wherein the color gamut information comprises one of a color gamut of an sYCC signal, a color gamut of an sRGB signal, and a color gamut of an xvYCC signal.

14. The method as claimed in claim 10, wherein the color gamut information is generated based on the image data.

15. A method of receiving color gamut information, comprising:
receiving data including image data and ancillary data; and
extracting color gamut information from the ancillary data.

16. The method as claimed in claim 15, further comprising:
signal processing the image data, based on the extracted color gamut information.

17. The method as claimed in claim 15, wherein the color gamut information is included in at least one of a data identification (ID) and a user data words section which are included in the ancillary data.

18. The method as claimed in claim 17, wherein the extracting of the color gamut information comprises extracting a color gamut ID, which is information indicating whether the color gamut information is included in the ancillary data, from the data ID section, and extracting the color gamut information from the user data words section.
